(19) United States
(12) Patent Application Publication
(10) Pub. No.: US 2026/0133904 A1
(43) Pub. Date: May 14, 2026

(54) MEMORY SYSTEM AND OPERATION METHOD OF IN-MEMORY COMPUTING

(71) Applicant: MACRONIX INTERNATIONAL CO., LTD., HSINCHU (TW)

(72) Inventors: Bo-Rong LIN, Taichung City (TW); Han-Wen HU, Hsinchu County (TW)

(21) Appl. No.: 19/096,837

(22) Filed: Apr. 1, 2025

Related U.S. Application Data
(60) Provisional application No. 63/718,751, filed on Nov. 11, 2024.

(51) Int. Cl. G06F 12/02

(52) U.S. Cl. CPC G06F 12/0246

(57) ABSTRACT

A memory system includes a storage controller, a memory, a first level filter and a second level filter. The storage controller configured to receive a first stage result. The memory configured to perform in-memory computing to the first stage result, to generate a second stage result. The first level filter configured to filter the second stage result to generate a third stage result. The second level filter configured to filter the third stage result to generate a fourth stage result. When a quantity of data results in the third stage result is larger than a predetermined threshold quantity, the memory system outputs the fourth stage result, and when the quantity of the data results in the third stage result is smaller than or equal to the predetermined threshold quantity, the memory system outputs the third stage result.

### CROSS-REFERENCE TO RELATED APPLICAITONS

This application claims priority to US Provisional Application Serial Number 63/718,751, filed November 11, 2024, which is herein incorporated by reference in its entirety.

### BACKGROUND

### Technical Field

The present disclosure relates to a memory technique. More particularly, the present disclosure relates to a memory system and an operation method of in-memory computing.

### Description of Related Art

Artificial intelligence (AI) has recently emerged as a highly effective solution for many classification tasks. The key operation in AI is that it contains large input feature maps and weights to perform multiply-and-accumulate (MAC) operations. However, the current Complementary Metal Oxide Semiconductor based (CMOS-based) Von Neumann architecture, such as central processing unit (CPU) or graphics processing unit (GPU) with external memory, encounters an input/output (IO) bottleneck and inefficient MAC operation flow. Thus, techniques associated with solving above problems are important issues in the field.

### SUMMARY

The present disclosure provides a memory system. The memory system includes a storage controller, a memory, a first level filter and a second level filter. The storage controller configured to receive a first stage result. The memory configured to perform in-memory computing to the first stage result, to generate a second stage result. The first level filter configured to filter the second stage result to generate a third stage result. The second level filter configured to filter the third stage result to generate a fourth stage result. When a quantity of data results in the third stage result is larger than a predetermined threshold quantity, the memory system outputs the fourth stage result, and when the quantity of the data results in the third stage result is smaller than or equal to the predetermined threshold quantity, the memory system outputs the third stage result.

The present disclosure provides an operation method of in-memory computing. The operation method includes: filtering a first stage result by a first level filter, to generate a second stage result; comparing a quantity of data results in the second stage result with a predetermined threshold quantity; and when the quantity of the data results in the second stage result is larger than the predetermined threshold quantity, filtering the second stage result by a second level filter, to generate a third stage result.

It is to be understood that both the foregoing general description and the following detailed description are examples, and are intended to provide further explanation of the disclosure as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of an operation method of in-memory computing, illustrated according to some embodiments of present disclosure.

FIG. 2 is a schematic diagram of a memory system, illustrated according to some embodiments of present disclosure.

FIG. 3 is a schematic diagram of accuracies of a testing dataset, illustrated according to some embodiments of present disclosure.

### DETAILED DESCRIPTION

In the present disclosure, when an element is referred to as "connected" or "coupled", it may mean "electrically connected" or "electrically coupled". "Connected" or "coupled" can also be used to indicate that two or more components operate or interact with each other. In addition, although the terms "first", "second", and the like are used in the present disclosure to describe different elements, the terms are used only to distinguish the elements or operations described in the same technical terms. The use of the term is not intended to be a limitation of the present disclosure.

Unless otherwise defined, all terms (including technical and scientific terms) used in the present disclosure have the same meaning as commonly understood by the ordinary skilled person to which the concept of the present invention belongs. It will be further understood that terms (such as those defined in commonly used dictionaries) should be interpreted as having a meaning consistent with its meaning in the related technology and/or the context of this specification and not it should be interpreted in an idealized or overly formal sense, unless it is clearly defined as such in this article.

The terms used in the present disclosure are only used for the purpose of describing specific embodiments and are not intended to limit the embodiments. As used in the present disclosure, the singular forms "a", "one" and "the" are also intended to include plural forms, unless the context clearly indicates otherwise. It will be further understood that when used in this specification, the terms "comprises (comprising)" and/or "includes (including)" designate the existence of stated features, steps, operations, elements and/or components, but the existence or addition of one or more other features, steps, operations, elements, components, and/or groups thereof are not excluded.

Hereinafter multiple embodiments of the present disclosure will be disclosed with schema, as clearly stated, the details in many practices it will be explained in the following description. It should be appreciated, however, that the details in these practices is not applied to limit the present disclosure. Also, it is to say, in some embodiments of the present disclosure, the details in these practices are non-essential. In addition, for the sake of simplifying schema, some known usual structures and element in the drawings by a manner of simply illustrating for it.

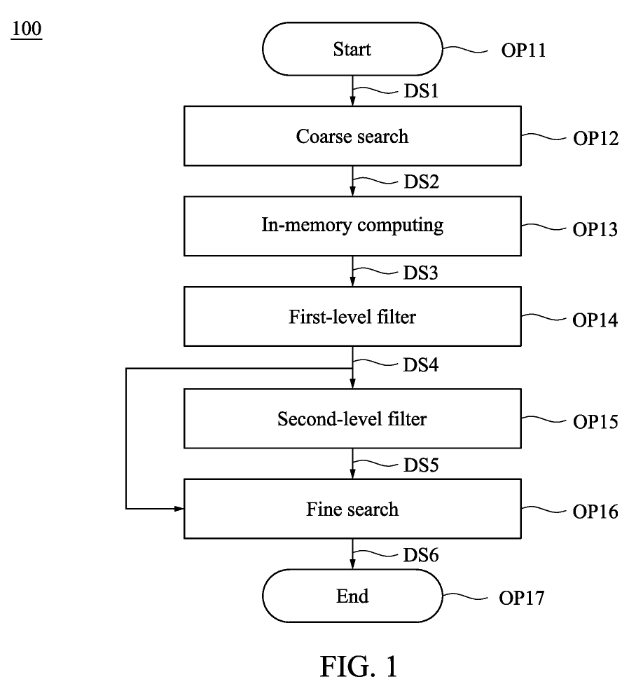

FIG. 1 is a schematic diagram of an operation method 100 of in-memory computing, illustrated according to some embodiments of present disclosure. In some embodiments, the operation method 100 can reduce the quantity of data results transmitted between different devices to accelerate the in-memory computing. In some embodiments, the operation method 100 can be implemented by a memory system including a memory and a processor.

As shown in FIG. 1, the operation method 100 includes operations OP11-OP17. In some embodiments, the operations OP11-OP17 are performed in order.

During the operation OP11, the system starts to perform the operation method 100.

During the operation OP12, the system performs a coarse search to a stage result DS1, to generate a stage result DS2.

During the operation OP13, the system inputs the stage result DS2 into the memory, and perform in-memory computing to the stage result DS2 and a database DTB stored in the memory, to generate a stage result DS3.

During the operation OP14, the system filters the stage result DS3 by a first level filter, to generate a stage result DS4. In which a quantity of multiple data results in the stage result DS4 is smaller than a quantity of multiple data results in the stage result DS3.

In some embodiments, the first level filter can be implemented by setting threshold values or machine learning. For example, the first level filter set 3 as the threshold value. When a data value of a data result in the stage result DS3 is smaller than 3, the first level filter passes the data result and assign the data result into the stage result DS4. When a data value of a data result in the stage result DS3 is larger than or equal to 3, the first level filter blocks the data result and does not assign the data result into the stage result DS4. Alternatively stated, in the example above, the stage result DS4 includes data results with data values smaller than 3 in the stage result DS3, and does not include data results with data values larger than or equal to 3 in the stage result DS3.

However, the embodiments of present disclosure are not limited to the exampled described above. In other embodiments, the first level filter can assign the data result having a data value larger than the threshold value to the stage result DS4. Specifically, when a data value of a data result in the stage result DS3 is larger than the threshold value, the first level filter passes the data result and assign the data result into the stage result DS4. When a data value of a data result in the stage result DS3 is smaller than or equal to the threshold value, the first level filter blocks the data result and does not assign the data result into the stage result DS4. Alternatively stated, in the example above, the stage result DS4 includes data results with data values larger than the threshold value in the stage result DS3, and does not include data results with data values smaller than or equal to the threshold value in the stage result DS3.

Then, the system compares the quantity of the data results in the stage result DS4 and a predetermined threshold quantity PTQ. When the quantity of the data results in the stage result DS4 is larger than the predetermined threshold quantity PTQ, after the operation OP14, the system activates a second level filter to perform the operation OP15 to the stage result DS4. When the quantity of the data results in the stage result DS4 is smaller than or equal to the predetermined threshold quantity PTQ, after the operation OP14, the system performs the operation OP16, without performing the operation OP15. In some embodiments, the predetermined threshold quantity PTQ can be equal to ten thousand.

During the operation OP15, the system filters the stage result DS4 by a second level filter, to generate a stage result DS5. In which a quantity of multiple data results in the stage result DS5 is smaller than the quantity of the data results in the stage result DS4.

In some embodiments, the second level filter can be implemented by a sorting algorithm. However, the embodiments of present disclosure are not limited to this. In other embodiments, the second level filter can be implemented by algorithm other than the sorting algorithm, such as Top K selection algorithm. Specifically, each of the data results in the stage result DS4 has a corresponding data value. For the embodiments of the sorting algorithm, the second level filter sorts the data results in the stage result DS4 according to the data values of the data results. For example, when a data value of a data result is smaller, the data result has a higher priority for the sorting algorithm. In contrast, when a data value of a data result is larger, the data result has a lower priority for the sorting algorithm.

However, the embodiments of present disclosure are not limited to the embodiment described above. In other embodiments, according to different distance algorithms, when a data value of a data result is larger, the data result may have a higher priority for the sorting algorithm. In contrast, when a data value of a data result is smaller, the data result has a lower priority for the sorting algorithm.

Then, the second level filter selects N1 data results with higher priorities from the stage result DS4 as the stage result DS5, in which N1 is a positive integer smaller than or equal to the predetermined threshold quantity PTQ. Alternatively stated, for the sorting algorithm, each of the priorities of the N1 data results is higher than priorities of the other data results in the stage result DS4.

For example, the positive integer N1 can be equal to five thousand. Correspondingly, the second level filter selects five thousand data results with smaller data values in the stage result DS4 as the stage result DS5. Each of the data values of the five thousand data results is smaller than the data values of the other data results in the stage result DS4. In such example, each of the data values of the five thousand data results is smaller than a threshold value, and each of the data values of the other data results in the stage result DS4 is larger than or equal to the threshold value.

In some alternative embodiments, the second level filter also can be implemented by algorithms other than the sorting algorithm. For example, the second level filter can be implemented by a Top K selection algorithm. In which K can be equal to N1.

After the operation OP15, during the operation OP16, the system performs a fine search to the stage result DS5, to generate a final filter result DS6. In some embodiments, the final filter result DS6 corresponds to search results of the operation method 100 of in-memory computing.

Referring to the operations OP12 and OP15, in some embodiments, the coarse search is for searching data in a larger range or coarser manner, while the fine search is for target specific data points or a specific range. In some embodiments, the coarse search is a pre-processing step of the fine search.

Under a condition that the quantity of the data results in the stage result DS4 is smaller than or equal to the predetermined threshold quantity PTQ, after the operation OP14, during the operation OP16, the system performs the fine search to the stage result DS4, to generate the final filter result DS6.

During the operation OP17, the operation method 100 is finished.

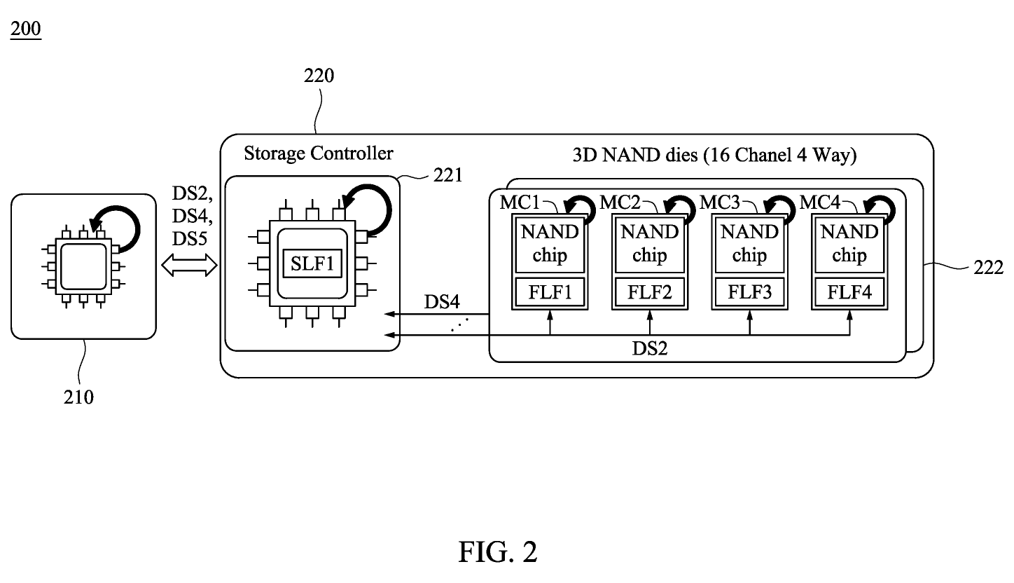

FIG. 2 is a schematic diagram of a system 200, illustrated according to some embodiments of present disclosure. As shown in FIG. 2, the system 200 includes a processing device 210 and a storage system 220. In some embodiments, the system 200 can be implemented by von-Neumann architecture. The processing device 210 can include a processor. The storage system 220 also can include a processor.

In some embodiments, the processing device 210 and the storage system 220 are configured to transmit data to each other, to process the data. For example, the storage system 220 can transmit the stage result DS4 or DS5 to the processing device 210, such that the processing device 210 can perform the fine search to the stage result DS4 or DS5, to generate the final filter result DS6.

In some embodiments, the processing device 210 can be implemented by a Central Processing Unit (CPU), and the storage system 220 can be implemented by a Solid-State Drive (SSD). However, the embodiments of the present disclosure are not limited to this. In some embodiments, the operation method 100 can also applied to a volatile memories based in-memory computing (IMC) system.

As shown in FIG. 2, the storage system 220 includes a storage controller 221 and a memory 222. The memory 222 can include one or more memory chips, in which a memory chip can include one or more memory die (one or more memory die can be packaged as a chip). In some embodiments, memory 222 includes multiple memory chips MC1-MC4.

In the embodiment shown in FIG. 2, the memory chips MC1-MC4 includes first level filters FLF1-FLF4, respectively, and the storage controller 221 includes a second level filter SLF1. However, the embodiments of the present disclosure are not limited to this. In some alternative embodiments, the memory chips MC1-MC4 can include the first level filter and the second level filter, such that the memory chips MC1-MC4 can perform each of the operations OP14 and OP15. In some other alternative embodiments, the storage controller 221 can include the first level filter and the second level filter, such that the storage controller 221 can perform each of the operations OP14 and OP15.

In some embodiments, the memory 222 can be implemented by multiple logic dies. For example, in the embodiment shown in FIG. 2, the memory 222 is implemented by multiple 3-dimensional (3D) NAND flash memory dies with 16 channels and 4 ways.

In some embodiments, the memory chips MC1-MC4 can be implemented by logic chips. For example, in the embodiment shown in FIG. 2, the memory chips MC1-MC4 are implemented by NAND flash memory logic chips. In summary, the memory 222 can be implemented by multiple memory chips (logic chips). The memory chip can be implemented by NAND flash memory chip. The NAND flash memory chip can be implemented by two-dimensional (2D) or three-dimensional NAND flash memory chip. The NAND flash memory chip can include a NAND flash memory die.

Referring to FIG. 1 and FIG. 2, in some embodiments, the operation method 100 can be performed by the system 200.

Specifically, during the operation OP12, the processing device 210 performs the coarse search to the stage result DS1, to generate the stage result DS2. In various embodiments, the processing device 210 can be implemented by CPU, GPU or other processing devices. Alternatively stated, the coarse search can be performed by CPU, GPU or other processing devices. Then, the storage controller 221 receives the stage result DS2 from the processing device 210, and transmits the stage result DS2 to the memory 222.

During operation OP13, the memory 222 receives the stage result DS2 from the storage controller 221, such that the memory chips MC1-MC4 perform in-memory computing to the stage result DS2 and a database DTB stored in the memory chips MC1-MC4, to generate the stage result DS3.

During operation OP14, the first level filters FLF1-FLF4 filter the stage result DS3 to generate the stage result DS4. Then, the storage controller 221 receives the stage result DS4, and compares the quantity of the data results in the stage result DS4 and the predetermined threshold quantity PTQ. In some embodiments, the storage controller 221 is configured to store the predetermined threshold quantity PTQ.

In some embodiments, the storage controller 221 is configured to count the data results in the stage result DS4 to generate the quantity of the data results in the stage result DS4. However, the embodiments of the present disclosure are not limited to this. In some alternative embodiments, the memory 222 is configured to count the data results in the stage result DS4 to generate the quantity of the data results in the stage result DS4, and transmit the quantity to the storage controller 221.

When the quantity of the data results in the stage result DS4 is larger than the predetermined threshold quantity PTQ, the storage controller 221 activates the second level filter SLF1 to perform the operation OP15 to the stage result DS4. When the quantity of the data results in the stage result DS4 is smaller than or equal to the predetermined threshold quantity PTQ, the storage controller 221 outputs the stage result DS4 to the processing device 210, and the processing device 210 performs the operation OP16 to the stage result DS4.

During operation OP15, the storage controller 221 filters the stage result DS4 by the second level filter SLF1, to generate the stage result DS5. Then, the storage controller 221 outputs the stage result DS5 to the processing device 210, and the processing device 210 performs the operation OP16 to the stage result DS5.

During the operation OP16, the processing device 210 performs the fine search to the stage result DS4 or the stage result DS5, to generate the final filter result DS6.

In some approaches, when in-memory computing is performed, the storage controller needs to transmit a large amount of data results to the processing device. As a result, the system will encounter input/output bottlenecks and computing bottlenecks. To resolve the bottlenecks, a layer of filters is added to the system to reduce the amount of computation and transmission. However, in some situations, the filtering effect is still poor.

Compared to above approaches, in some embodiments of present disclosure, the storage controller 221 activates the second level filter SLF1 when the quantity of the data results in the stage result DS4 is larger than the predetermined threshold quantity PTQ, to generate the stage result DS5. As a result, an amount of transmission of the storage controller 221 and an amount of computation of the processing device 210 can be reduced.

In some embodiments, the in-memory computing filter can also be implemented for von-Neumann solution. In the embodiments shown in FIG. 1 and FIG. 2, the system includes the first level filter and the second level filter. However, the embodiments of present disclosure are not limited to this. In various embodiments, the system can include more levels of filters.

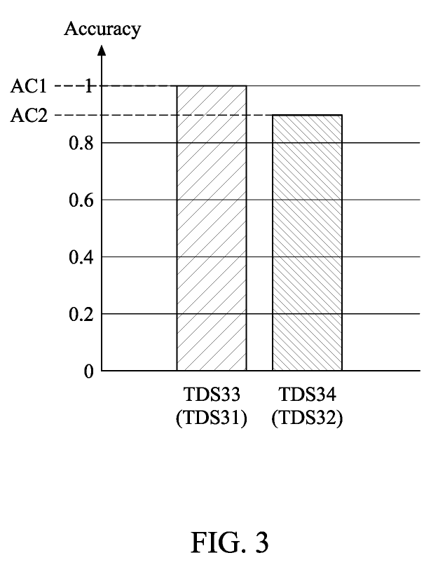

FIG. 3 is a schematic diagram of accuracies of a testing dataset TDS1, illustrated according to some embodiments of present disclosure. A vertical axis of FIG. 3 corresponds to the accuracies. FIG. 3 includes accuracies AC1 and AC2.

Referring to FIG. 1 and FIG. 3, the accuracies AC1 and AC2 can be configured to determine the positive integer N1 of the operation OP15. In some embodiments, the system performs the operations OP12-OP14 in sequence to the testing dataset TDS1 to generate a testing dataset TDS31, and performs the operation OP15 to the testing dataset TDS31 to generate a testing dataset TDS32.

Alternatively stated, the system filters the testing dataset TDS1 by the first level filter to generate the testing dataset TDS31, and filters the testing dataset TDS31 by the second level filter to generate the testing dataset TDS32.

Then, the system performs the operation OP16 to the testing dataset TDS31 to generate a testing dataset TDS33, and performs the operation OP16 to the testing dataset TDS32 to generate a testing dataset TDS34. Specifically, the system performs the fine search operation to the testing dataset TDS31 to generate the testing dataset TDS33, and performs the fine search operation to the testing dataset TDS32 to generate the testing dataset TDS34.

In some embodiments, the positive integer N1 can be determined offline. After the positive integer N1 is determined, the system 200 is online and starts to operate. When the system 200 is online and starts to operate, the positive integer N1 can be maintained invariant.

Specifically, the system 200 can filter the testing dataset TDS1 without the second level filter, to generate a filter result without the second level filter. On the other hand, the system 200 can filter the testing dataset TDS1 with the second level filter, to generate a filter result with the second level filter. The system 200 can verify whether a large difference between the accuracy of filter result without the second level filter and the accuracy of filter result with the second level filter. Specifically, the system 200 can verify whether the accuracy of filter result with the second level filter matches a predetermined accuracy. If the accuracy of filter result with the second level filter does not match the predetermined accuracy, the system 200 can increase the positive integer N1. If the accuracy of filter result with the second level filter matches the predetermined accuracy, the system 200 can be online and start to operate.

For example, under a condition that the positive integer N1 is equal to two thousand, the system 200 uses the second level filter to generate an accuracy corresponding to two thousand. In response to the accuracy corresponding to two thousand being smaller than the predetermined accuracy, the system 200 increases the positive integer N1 to three thousand. Then, the system 200 uses the second level filter to generate an accuracy corresponding to three thousand. In response to the accuracy corresponding to two thousand being larger than the predetermined accuracy, the system 200 use three thousand as the positive integer N1, and is online and starts to operate.

In summary, the positive integer N1 can be determined based on a verification index. In some embodiments, the verification index can be the accuracy, the recall rate or other verification index.

As shown in FIG. 3, the accuracy AC1 is the accuracy of the testing dataset TDS33, and the accuracy AC1 is the accuracy of the testing dataset TDS34. Alternatively stated, the accuracy AC1 is the accuracy without the processing of the second level filter, and corresponds to the testing dataset TDS31. The accuracy AC2 is the accuracy with the processing of the second level filter, and corresponds to the testing dataset TDS32. In some alternative embodiments, the accuracies described herein can be replaced by recall rates.

In general, the accuracy is proportional to a quantity of data results in a corresponding dataset. Specifically, the accuracy AC1 is proportional to a quantity of multiple data results in the testing dataset TDS31, and the accuracy AC2 is proportional to a quantity of multiple data results in the testing dataset TDS32. In response to the quantity of the data results in the testing dataset TDS32 is smaller than the quantity of the data results in the testing dataset TDS31, the accuracy AC2 is smaller than the accuracy AC1.

However, the embodiments of present disclosure are not limited to this. In some embodiments, the positive integer N1 can be determined online, for example, the system can compare the accuracy AC2 and a predetermined accuracy. When the accuracy AC2 is smaller than the predetermined accuracy, the system increases the positive integer N1. When the accuracy AC2 is larger than or equal to the predetermined accuracy, the system determines the positive integer N1, and performs the operation OP15 to the stage result DS4 shown in FIG. 1 with the determined positive integer N1. In some embodiments, the predetermined accuracy can be equal to the accuracy AC1. Correspondingly, in such embodiments, the accuracy AC2 is not lager than the predetermined accuracy. However, the embodiments of present disclosure are not limited to this. In other embodiments, the predetermined accuracy can be smaller than the accuracy AC1. Correspondingly, in such embodiments, the accuracy AC2 may be between the predetermined accuracy and the accuracy AC1.

Alternatively stated, the system determines the positive integer N1 according to the accuracy AC2 corresponding to the testing dataset TDS1, and the second level filter can filter the stage result DS4 according to the determined positive integer N1, to ensure the following final filter result DS6 has enough accuracy. In some embodiments, the testing dataset TDS1 can include ten thousand data points.

In some embodiments, the predetermined accuracy can be equal to the accuracy AC1 multiplied by a predetermined accuracy ratio. For example, the predetermined accuracy is equal to the accuracy AC1 multiplied by 0.8, in which the predetermined accuracy ratio is equal to 0.8. However, the embodiments of present disclosure are not limited to this. In various embodiments, the predetermined accuracy ratio can be equal to 0.9 or other numbers.

Referring to FIG. 2 and FIG. 3, in some embodiments, the system 200 can further include a processor (not shown in figures) configured to perform the operations associated with FIG. 3. For example, the processor can compare the accuracy AC2 and a predetermined accuracy, to determine the positive integer N1. Furthermore, the first level filter performing the operations associated with FIG. 3 can be implemented by the first level filters FLF1-FLF4, and the second level filter performing the operations associated with FIG. 3 can be implemented by the second level filter SLF1.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A memory system, comprising:
a storage controller configured to receive a first stage result; and
a memory configured to perform in-memory computing to the first stage result, to generate a second stage result;
a first level filter configured to filter the second stage result to generate a third stage result; and
a second level filter configured to filter the third stage result to generate a fourth stage result,
wherein when a quantity of data results in the third stage result is larger than a predetermined threshold quantity, the memory system outputs the fourth stage result, and
when the quantity of the data results in the third stage result is smaller than or equal to the predetermined threshold quantity, the memory system outputs the third stage result.

2. The memory system of claim 1, wherein
the storage controller configured to output the third stage result or the fourth stage result to a processing device.

3. The memory system of claim 2, wherein
the storage controller includes the second level filter, and
the memory includes the first level filter.

4. The memory system of claim 2, wherein
the storage controller includes the first level filter and the second level filter.

5. The memory system of claim 2, wherein
the memory includes the first level filter and the second level filter.

6. The memory system of claim 2, wherein the first level filter is configured to set a threshold value to filter the second stage result.

7. The memory system of claim 2, wherein the second level filter is configured to filter the third stage result by a sorting algorithm to generate the fourth stage result.

8. The memory system of claim 2, wherein the second level filter is configured to filter the third stage result by algorithm different from a sorting algorithm to generate the fourth stage result.

9. The memory system of claim 2, wherein the second level filter is further configured to sort the data results in the third stage result according to data values of the data results in the third stage result, and select N1 data results from the third stage result as the fourth stage result, and
N1 is a positive integer smaller than or equal to the predetermined threshold quantity.

10. The memory system of claim 9, wherein N1 is determined based on a verification index corresponding to a first testing dataset.

11. The memory system of claim 10, wherein the verification index is a recall rate.

12. The memory system of claim 10, wherein the verification index is an accuracy.

13. The memory system of claim 12, wherein the first level filter is further configured to filter the first testing dataset to generate a second testing dataset,
the second level filter is further configured to filter the second testing dataset to generate a third testing dataset, and
the memory system is configured to adjust N1 according to a first accuracy corresponding to the second testing dataset and a second accuracy corresponding to the third testing dataset.

14. The memory system of claim 13, wherein the memory system is further configured to compare the second accuracy with a predetermined accuracy,
when the second accuracy is smaller than the predetermined accuracy, the memory system increases N1, and
when the second accuracy is larger than or equal to the predetermined accuracy, the memory system determines N1.

15. An operation method of in-memory computing, comprising:
filtering a first stage result by a first level filter, to generate a second stage result;
comparing a quantity of data results in the second stage result with a predetermined threshold quantity; and
when the quantity of the data results in the second stage result is larger than the predetermined threshold quantity, filtering the second stage result by a second level filter, to generate a third stage result.

16. The operation method of claim 15, wherein the second level filter is configured to filter the second stage result by a sorting algorithm to generate the third stage result.

17. The operation method of claim 15, wherein the second level filter is configured to filter the second stage result by an algorithm different from a sorting algorithm to generate the third stage result.

18. The operation method of claim 15, wherein the first level filter is configured to set a threshold value to filter the first stage result.

19. The operation method of claim 15, wherein filtering the second stage result to generate the third stage result comprises:
sorting, by the second level filter, the data results in the second stage result according to data values of the data results in the second stage result; and
selecting, by the second level filter, N1 data results from the second stage result as the third stage result,
wherein N1 is a positive integer smaller than or equal to the predetermined threshold quantity.

20. The operation method of claim 19, wherein N1 is determined based on a verification index corresponding to a first testing dataset.
